(19) United States
(12) Patent Application Publication
(10) Pub. No.: US 2019/0163958 A1
(43) Pub. Date: May 30, 2019

(54) METHODS AND ASSOCIATED SYSTEMS FOR GRID ANALYSIS

(71) Applicant: SZ DJI TECHNOLOGY CO., LTD., Shenzhen (CN)

(72) Inventors: Wei Li, Shenzhen (CN); Lu Ma, Shenzhen (CN)

(21) Appl. No.: 16/265,064

(22) Filed: Feb. 1, 2019

Related U.S. Application Data
(63) Continuation of application No. PCT/CN17/82605, filed on Apr. 28, 2017.

(51) Int. Cl. G06K 9/00; G06T 15/08; G06T 7/90; G01S 17/42; G01S 17/93

(52) U.S. Cl. CPC G06K 9/00201; G06K 9/00791; G06T 15/08; G06T 7/90; G06T 2207/10032; G01S 17/42; G01S 17/936; G06T 2207/10028; G06T 2207/30252; G06K 9/0063

(57) ABSTRACT

Methods of route planning for a moveable device and associated systems are disclosed herein. In representative embodiments, the method includes (1) downsampling a 3-D point cloud generated by a distance-measurement component of the movable device to obtain a downsampled point cloud; (2) extracting ground points from the downsampled point cloud; (3) analyzing the ground points in a surface-detecting direction; and (4) identifying an object based at least in part on the downsampled point cloud and the ground points. The identified object and the ground points can be used for planning a route for the moveable device.

### TECHNICAL FIELD

The present technology is directed generally to methods for planning routes for a movable device (e.g., a ground vehicle or an unmanned aerial vehicle (UAV)) and associated systems. More particularly, the present technology relates to methods using voxel grids or three-dimensional (3-D) grids to analyze a point cloud generated by a distance-measurement component.

### BACKGROUND

Range-finding and distance-measurement techniques are important for route planning tasks for a vehicle. After a range-finding or distance-measurement process, a user can collect raw data associated with objects in a surrounding environment. The collected raw data usually includes a large amount of information that requires further analysis. Analyzing the collected raw data can be time-consuming and sometimes challenging, due to time constraints or other limitations (e.g., limited computing resources). Therefore, it would be beneficial to have an improved system that can effectively and efficiently analyze the collected raw data. Sometimes, the collected raw data can include a significant amount of noise or unwanted information. Accordingly, it would be advantageous to have an improved system that can effectively and efficiently screen out the noise or unwanted information so as to generate useful and meaningful information for further processing.

### SUMMARY

The following summary is provided for the convenience of the reader and identifies several representative embodiments of the disclosed technology. Generally speaking, the present technology provides an improved method for identifying objects or planning routes for a movable device (e.g., an autonomous ground vehicle or a UAV). In particular embodiments, the present technology uses a distance-measurement component (e.g., a component that can emit electromagnetic rays and receive corresponding reflected electromagnetic rays) to collect environmental data from surrounding environments. Examples of the environmental data include multiple three-dimensional (3-D) points (or collectively a point cloud) and images (e.g., a picture or video) surrounding the moveable device.

For example, each of the 3-D points can represent a location from which an incident electromagnetic ray is reflected back to the distance-measurement component. These 3-D points can be used to determine (1) whether there is an object or obstacle surrounding the moveable device or (2) a surface of an object or a ground/road surface on which the moveable device is traveling. Once an object/obstacle (or a surface) is identified, the method can further analyze what the identified object/obstacle is (or how the surface looks). For example, the object can be identified as a pedestrian, an animal, a moving object (e.g., another moveable device), a flying object, a building, a sidewalk plant, or other suitable items. In some embodiments, the present technology can identify the object/obstacle based on empirical data (e.g., cloud points of previously identified and confirmed objects). In some embodiments, the identified object/obstacle can be further verified by collected image data. For example, an object can be first identified as a pedestrian, and then the identification can be confirmed by reviewing an image of that pedestrian. As used herein, the term “image” refers generally to an image that has no distance/depth information or less depth/distance information than the point cloud.

To effectively and efficiently analyze collected 3-D points, embodiments of the present technology include assigning individual 3-D points to one of multiple voxel or 3-D grids based on the 3-D points' locations. The method then identifies a subset of 3-D grids (e.g., based on the number of assigned points in a 3-D grid) that warrants further analysis. The process of identifying the subset of grids is sometimes referred to as “downsampling” in this specification. Via the downsampling process, the present technology can effectively screen out noise or redundant part of the point cloud (which may consume unnecessary computing resources to analyze). Embodiments of the present technology can also include identifying objects in particular areas of interest (e.g., the side of a vehicle, an area in the travel direction of a vehicle, or an area beneath a UAV) and then plan routes (e.g., including avoiding surrounding objects/obstacles) for a moveable device accordingly. In some embodiments, the present technology can adjust the resolution of the 3-D grids (e.g., change the size of the grids) in certain areas of interest such that a user can better understand objects in these areas (e.g., understand that an object to the side of a moveable device is a vehicle or a pedestrian). In some embodiments, an initial size of the voxel grids can be determined based on empirical data.

Embodiments of the present technology also provide an improved method for identifying a ground surface (e.g., a road surface on which a moveable device travels) or a surface of an object/obstacle. Based on the identified subset of grids (which corresponds to a downsampled point cloud) and the corresponding 3-D points, the method can effectively and efficiently generate a ground surface that can be further used for route planning.

More particularly, a representative method includes determining a reference surface (e.g., a hypothetical surface that is lower than the actual ground surface on which the moveable device travels). The method then observes the corresponding 3-D points in a direction perpendicular to the reference surface. The individual downsampled cloud points can then be assigned to one of multiple grid columns or grid collections (as described later with reference to FIG. 3). The method then selects, for each grid column, a point closest to the reference surface (e.g., a point with a minimum height value relative to the reference surface). In some embodiments, for each grid column, multiple points relatively close to the reference surface can be selected. The selected points of all the grid columns are collectively considered ground points. Based on the ground points, a first (or an initial) ground surface can be determined (e.g., by connecting or interpolating between the ground points). The method can perform a gradient variation analysis on the ground points so as to form a second (or analyzed) ground surface.

The gradient variation analysis can be performed in various predetermined directions. In some embodiments, the method can generate multiple “virtual” ground-point-identifying rays so as to identify the ground points to be analyzed. For example, these “virtual” ground-point-identifying rays can be in directions (e.g., surface-detecting directions) outwardly from a distance-measurement component. For example, these virtual rays can be used to identify ground points in a 360-degree region, a 180-degree region, a 90-degree region, a 45-degree region, or other suitable region. In some embodiments, the surface-detecting directions can be determined based on a previous scanning region (e.g., from which the cloud points were collected, so as to ensure that the virtual ground-point-identifying rays can identify at least some ground points in these surface-detecting directions). For example, embodiments of the present technology can generate multiple virtual ground-point-identifying rays in directions corresponding to at least one emitted electromagnetic ray in a scanning region (e.g., one ray rotates and scans across a scanning region).

After determining the surface-detecting directions, a set of ground points is identified in these directions by virtual ground-point-identifying rays (to be discussed in detail with reference to FIGS. 4A-4E). A gradient value (e.g., a slope or an angle) at each identified ground point is then determined (e.g., the slope of a virtual ground-point-identifying ray at each identified ground point). The determined gradient values are then analyzed along each of the virtual ground-point-identifying rays. If the variation of the gradient values exceeds a threshold value, accordingly the ground points are adjusted (e.g., adjust their height values relative to the reference surface).

For example, a virtual ground-point-identifying ray can identify a first ground point (which has a first height value relative to the reference surface). The virtual ground-point-identifying ray can later identify a second ground point (which has a second height value relative to the reference surface). The first ground point is closer to the distance-measurement component than the second ground point. A first gradient value at the first ground point can be determined to be 20 degrees. For example, an angle formed by the ground-point-identifying ray and the reference surface may be 20 degrees, as described later with reference to FIG. 4B. A second gradient value at the second ground point can be determined to be 70 degrees. A gradient variation (e.g., 50 degrees) can then be determined based on the difference between the first and second gradient values. Assuming that the threshold value is set as 45 degrees, then the second height value is replaced by the first height value (to be discussed in further detail with reference to FIGS. 4A-4D).

One rationale for the adjustment can be that a sudden change of gradient at the second ground point may be caused by the presence of an object. The object can be or can include a projection, a protrusion or an article, and/or the object can be or can include a recess or a hole. Whatever the shape of orientation of the object, the height values of the ground points can be adjusted based on the gradient variation analysis as mentioned above to improve the fidelity of the identified ground surface, e.g., to better reflect the presence of the object. In some embodiments, the threshold value can be determined based on empirical data or other suitable factors (e.g., sizes of the voxel grids, characteristics of the cloud point, or other suitable factors).

In some embodiments, the virtual ground-point-identifying ray can be a virtual ray from the distance-measurement component to the identified ground points (e.g., R₁, R₂ and R₃ shown in FIG. 4B). In such embodiments, the gradient values of the ground points can be angles formed by the virtual ground-point-identifying ray and the reference surface 304 (e.g., angles θ_{R1}, θ_{R2} and θ_{R3} shown in FIG. 4B). In other embodiments, the virtual ground-point-identifying ray can be a virtual ray from one ground point to another ground point (e.g., R₁ and R₂ shown in FIG. 4C). In such embodiments, the gradient values of the ground points can still be angles formed by the virtual ground-point-identifying ray and a reference surface (e.g., angles θₖ and θₖ₊₁ shown in FIG. 4C).

After the gradient variation analysis, a second (or analyzed) ground surface (or analyzed ground points) can be generated. As a result, the present technology can provide an accurate, analyzed ground surface in a timely manner, without requiring undue computing resources. The analyzed ground surface can be further used for planning routes for moveable devices. For example, the analyzed ground surface can be used as a road surface on which a vehicle travels. Based on the road surface and the identified objects, a route for the vehicle can be planned (e.g., based on a predetermined rule such as a shortest route from point A to point B without contacting any identified objects).

Advantages of the present technology include that it can be used to process a wide range of collected raw data. For example, the present technology can effectively process an unevenly-distributed point cloud (e.g., having more 3-D points in a short range and fewer 3-D points in a long range) and then generate an analyzed ground surface for further process. Another benefit of the present technology is that it can dynamically adjust the size of the grids when the moveable device travels. By so doing, the present technology provides flexibility for users to select suitable methods for analyzing collected raw data.

### BRIEF DESCRIPTION OF THE DRAWINGS

FIG. 1A is a schematic diagram (top view) illustrating a movable device configured in accordance with representative embodiments of the present technology.

FIG. 1B is a schematic diagram illustrating a system configured in accordance with representative embodiments of the present technology.

FIG. 2 is a schematic, isometric diagram illustrating voxel grids and a point cloud configured in accordance with representative embodiments of the present technology.

FIG. 3 is a schematic diagram (cross-sectional view) illustrating a movable device configured in accordance with representative embodiments of the present technology. The moveable device is configured to identify characteristics of a ground surface on which it moves.

FIGS. 4A-4D are schematic diagrams illustrating methods for analyzing a ground surface in accordance with representative embodiments of the present technology.

FIG. 5A is a schematic diagram (top view) illustrating methods for identifying objects by various types of grids in accordance with representative embodiments of the present technology.

FIGS. 5B and 5C are schematic diagrams illustrating methods for analyzing cloud points in accordance with representative embodiments of the present technology.

FIG. 5D is a schematic diagram (top view) illustrating methods for identifying a ground-surface texture via various types of grids in accordance with representative embodiments of the present technology.

FIG. 6 is a schematic diagram illustrating a UAV configured in accordance with representative embodiments of the present technology.

FIG. 7 is a flowchart illustrating a method in accordance with representative embodiments of the present technology.

FIG. 8 is a flowchart illustrating a method in accordance with representative embodiments of the present technology.

### DETAILED DESCRIPTION

One aspect of the present technology is directed to a method for identifying an object located relative to a movable device. In representative embodiments, the movable device has a distance-measurement component configured to generate a 3-D point cloud. The method includes (1) downsampling a 3-D point cloud generated by the distance-measurement component to obtain a downsampled point cloud; (2) extracting ground points from the downsampled point cloud; (3) analyzing the ground points in a surface-detecting direction; and (4) identifying the object based at least in part on the downsampled point cloud and the ground points.

Another aspect of the present technology is directed to a system for identifying an object located relative to a movable device. In some embodiments, the system includes (i) a distance-measurement component configured to generate a 3-D point cloud and (ii) a computer-readable medium coupled to the distance-measurement component. The computer-readable medium is configured to (1) downsample the 3-D point cloud generated by the distance-measurement component using voxel grids to obtain a downsampled point cloud; (2) extract ground points from the downsampled point cloud; (3) analyze the ground points in a surface-detecting direction; and (4) identify the object based at least in part on the downsampled point cloud and the ground points.

Yet another aspect of the present technology is directed to a method for operating a movable device having a distance-measurement component. The method includes (1) determining a moving direction of the moveable device; (2) emitting, by the distance-measurement component, at least one electromagnetic ray; (3) receiving, by the distance-measurement component, a plurality of reflected electromagnetic rays; (4) acquiring a plurality of 3-D points based at least in part on the reflected electromagnetic rays; (5) assigning individual 3-D points to a plurality of voxel grids; (6) identifying a subset of the voxel grids based at least in part on a number of the 3-D points in individual voxel grids, and the subset of grids includes a set of 3-D points; (7) identifying, from the set of 3-D points, a first grid collection having one or more 3-D girds; (8) identifying, from the set of 3-D points, a second grid collection having one or more 3-D girds; (9) for each grid collection, selecting the 3-D point closest to a reference surface to generate the ground points; (10) determining a ground surface based at least in part on a gradient variation of the ground points in a surface-detecting direction; and (11) identifying an object based at least in part on the set of 3-D points and the ground surface.

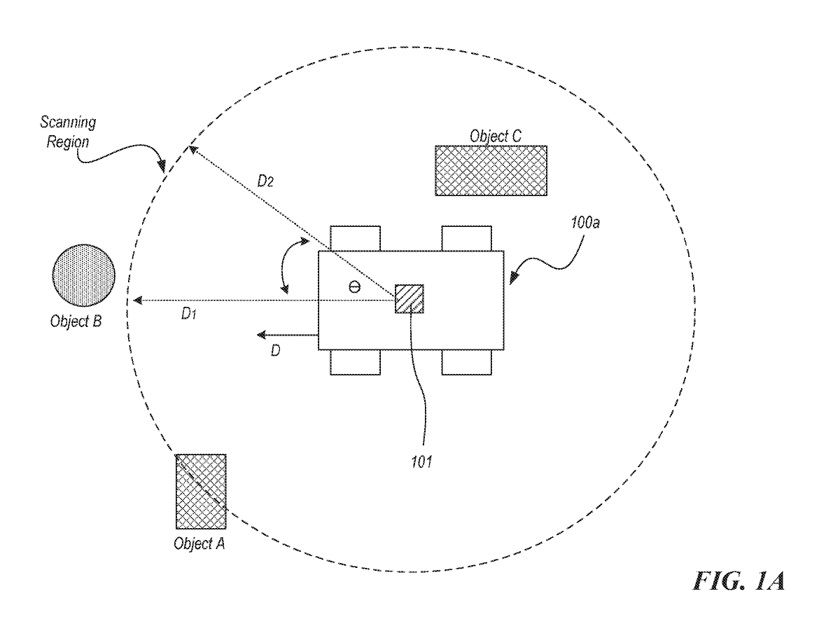

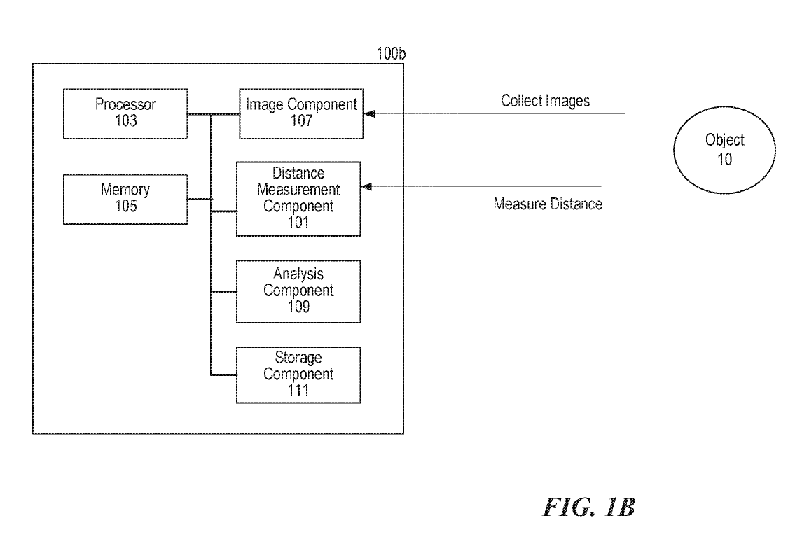

Several details describing structures or processes that are well-known and often associated with electrical motors and corresponding systems and subsystems, but that may unnecessarily obscure some significant aspects of the disclosed technology, are not set forth in the following description for purposes of clarity. Moreover, although the following disclosure sets forth several embodiments of different aspects of the technology, several other embodiments can have different configurations and/or different components than those described in this section. Accordingly, the technology may have other embodiments with additional elements and/or without several of the elements described below with reference to FIGS. 1A-8.

FIGS. 1A-8 are provided to illustrate representative embodiments of the disclosed technology. Unless provided for otherwise, the drawings are not intended to limit the scope of the claims in the present application. Many embodiments of the technology described below may take the form of computer- or controller-executable instructions, including routines executed by a programmable computer or controller. Those skilled in the relevant art will appreciate that the technology can be practiced on computer or controller systems other than those shown and described below. The technology can be embodied in a special-purpose computer or data processor that is specifically programmed, configured or constructed to perform one or more of the computer-executable instructions described below. Accordingly, the terms “computer” and “controller” as generally used herein refer to any suitable data processor and can include Internet appliances and handheld devices (including palm-top computers, wearable computers, cellular or mobile phones, multi-processor systems, processor-based or programmable consumer electronics, network computers, mini computers, a programmed computer chip, and the like). Information handled by these computers and controllers can be presented at any suitable display medium, e.g., a liquid crystal display (LCD). Instructions for performing computer- or controller-executable tasks can be stored in or on any suitable computer-readable medium, including hardware, firmware or a combination of hardware and firmware. Instructions can be contained in any suitable memory device, including, for example, a flash drive, USB device, or other suitable medium. In particular embodiments, the term “component” can include hardware, firmware, or a set of instructions stored in a computer-readable medium.

FIG. 1A is a schematic diagram (top view) illustrating a movable device 100a configured in accordance with representative embodiments of the present technology. In FIG. 1A, the moveable device 100a can be a vehicle moving in a moving or travel direction D. The moveable device 100a carries a distance-measurement component 101 configured to emit electromagnetic rays and receive reflected rays. The distance-measurement component 101 is configured to detect objects A, B and C surrounding the moveable device 100a. In some embodiments, the distance-measurement component 101 can emit a continuous electromagnetic ray and move the ray in different directions (e.g., directions D₁ and D₂). In some embodiments, the distance-measurement component 101 can emit a continuous electromagnetic ray in a scanning region defined by a scanning angle (e.g., angle θ defined by directions D₁ and D₂). In some embodiments, the scanning angle can be a 360-degree angle. In such embodiments, the corresponding scanning region can be a circle indicated by a dashed line in FIG. 1A. In some embodiments, the distance-measurement component 101 can include only one emitter that continuously scans or rotates in the scanning region (e.g., a hemispherical space, a spherical space, a conical space, a circular sector, or other suitable space/shapes). In some embodiments, the distance-measurement component 101 can include two or more emitters that emit rays in different directions simultaneously. In some embodiments, the distance-measurement component 101 can include one or more receivers configured to receive reflected rays generated by an object/obstacle or a road surface.

In some embodiments, the distance-measurement component 101 can include a Lidar (light detection and range) device, a Ladar (laser detection and range) device, a range finder, a range scanner, or other suitable devices. In some embodiments, the distance-measurement component 101 can be positioned on a top surface of the moveable device 100a (e.g., the rooftop of a vehicle). In some embodiments, the distance-measurement component 101 can be positioned on a side of to the moveable device 100a (e.g., a lateral side, a front side, or a back side). In some embodiments, the distance-measurement component 101 can be positioned on a bottom surface of the moveable device 100a (e.g., positioned on the bottom surface of a UAV). In some embodiments, the distance-measurement component 101 can be positioned at a corner of the moveable device 100a.

FIG. 1B is a schematic diagram illustrating a moveable system 100b configured in accordance with representative embodiments of the present technology. As shown, the system 100b includes a processor 103, a memory 105, an image component 107, a distance-measurement component 101, an analysis component 109, and a storage component 111. The processor 103 is coupled to other components of the system 100b and configured to control the same. The memory 105 is coupled to the processor 103 and configured to temporarily stores instructions, commands, or information associated with other components in the system 100b.

The image component 107 is configured to collect images external to the system 100b. In particular embodiments, the image component 107 is configured to collect images corresponding to an object 10 (or a target surface). In some embodiments, the image component 107 can be a camera that collects two-dimensional images with red, green, and blue (RGB) pixels (e.g., based on which color pattern is suitable for further use, such as verifying identified objects/obstacles/surfaces). The collected images can be stored in the storage component 111 for further processing/analysis. In particular embodiments, the storage component 111 can include a disk drive, a hard disk, a flash drive, or the like. In some embodiments, the image component 107 can be a thermal image camera, night vision camera, or any other suitable device that is capable of collecting images corresponding to the object 10.

In particular embodiments, the distance-measurement component 101 is configured to measure a distance between the object 10 and the system 100b. The distance-measurement component 101 can includes a time-of-flight (ToF) sensor that measures a distance to an object by measuring the time it takes for an emitted electromagnetic ray to strike the object and to be reflected to a detector. The ray can be a light ray, laser beam, or other suitable electromagnetic ray. Distance information (e.g., a point cloud having multiple 3-D points) collected by the distance-measurement component 101 can be stored in the storage component 111 for further processing/analysis. In some embodiments, the distance-measurement component 101 can include a stereo camera or a binocular camera.

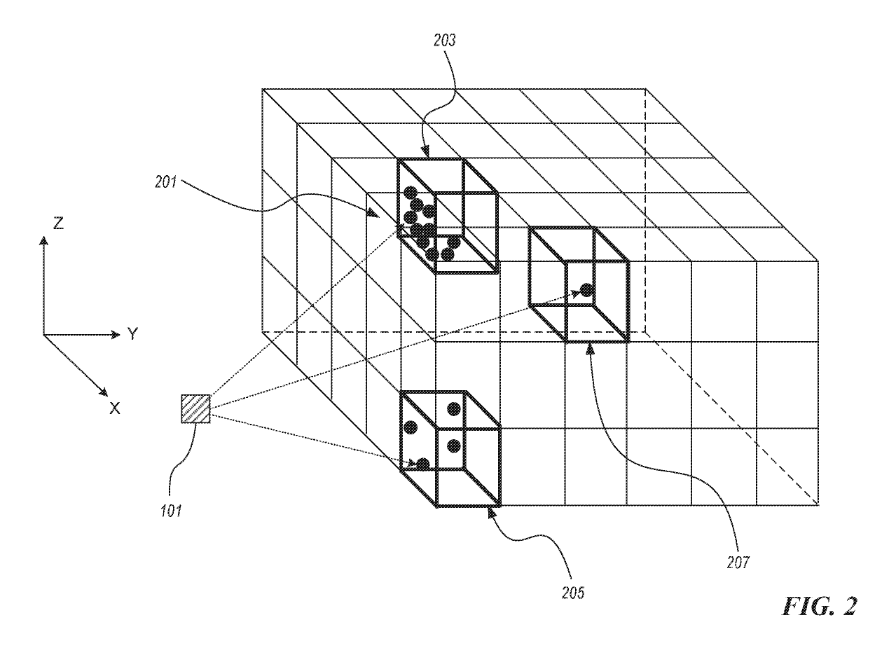

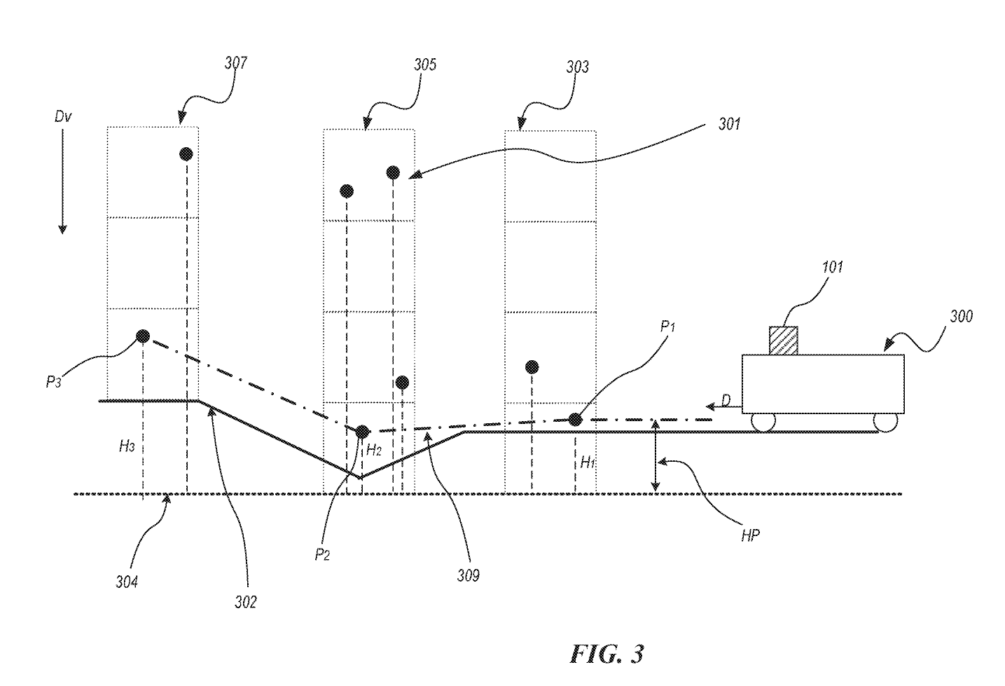

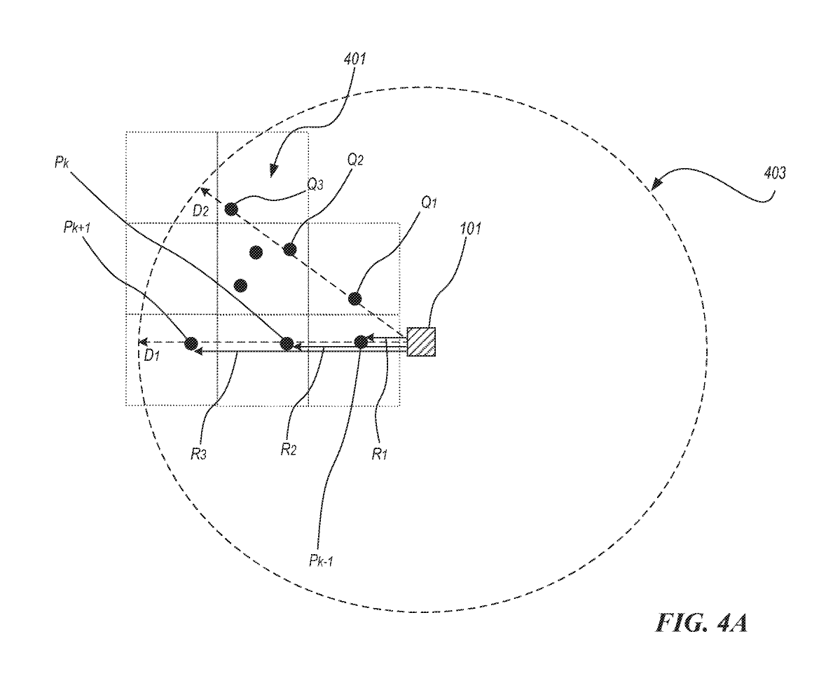

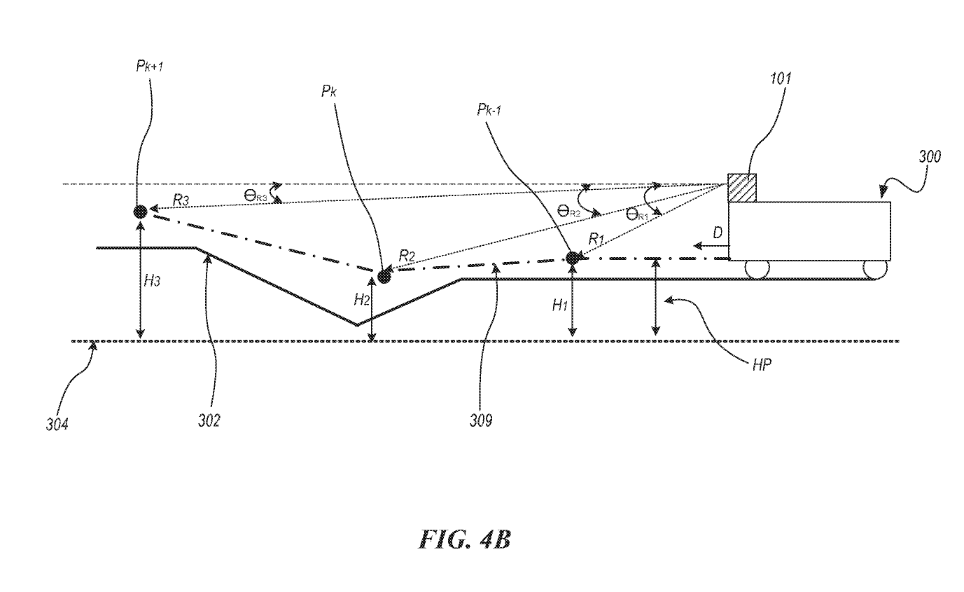

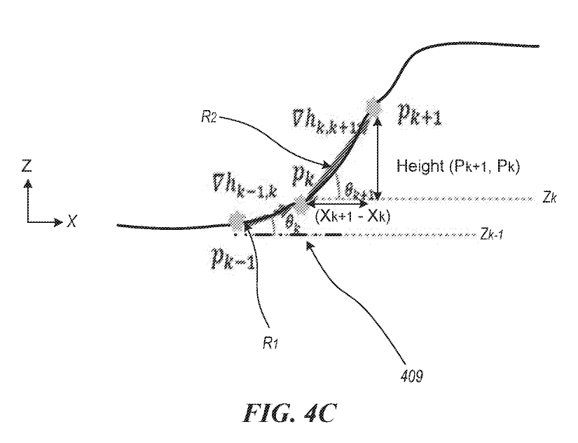

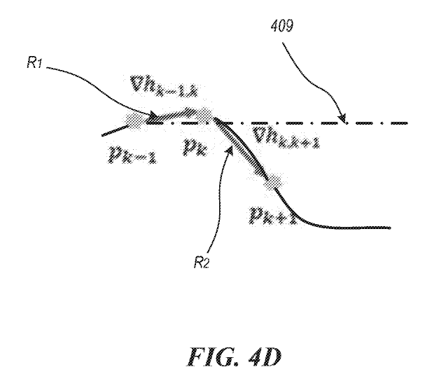

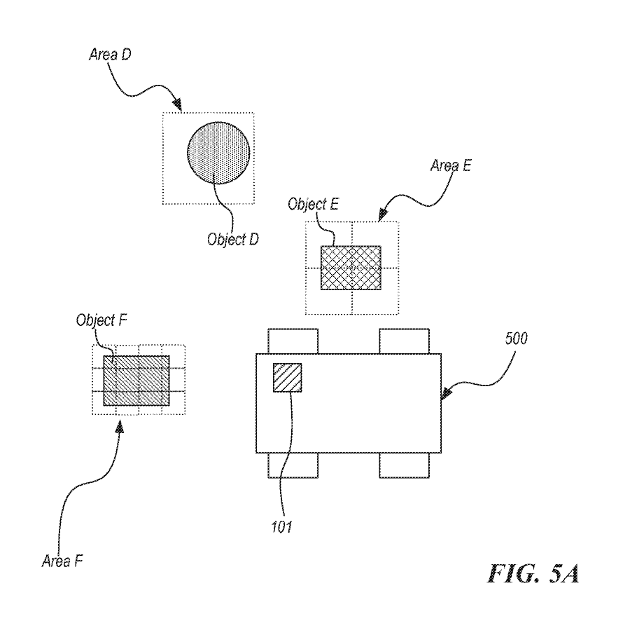

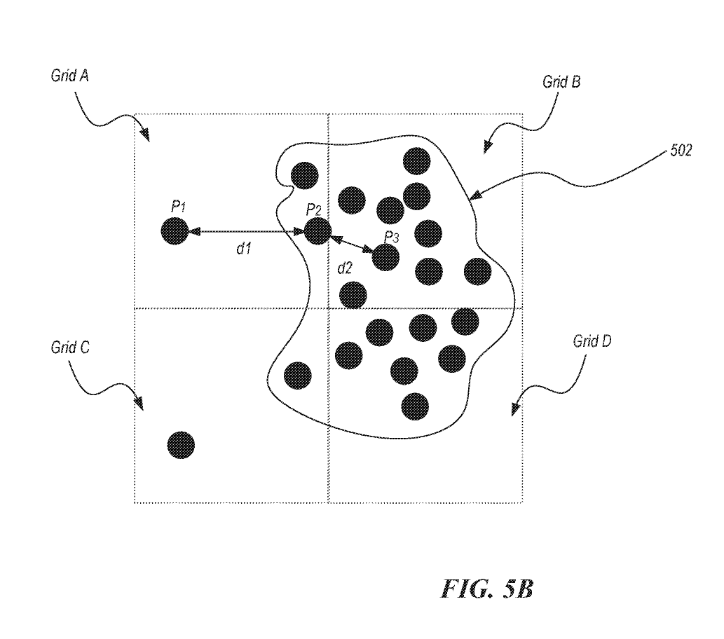

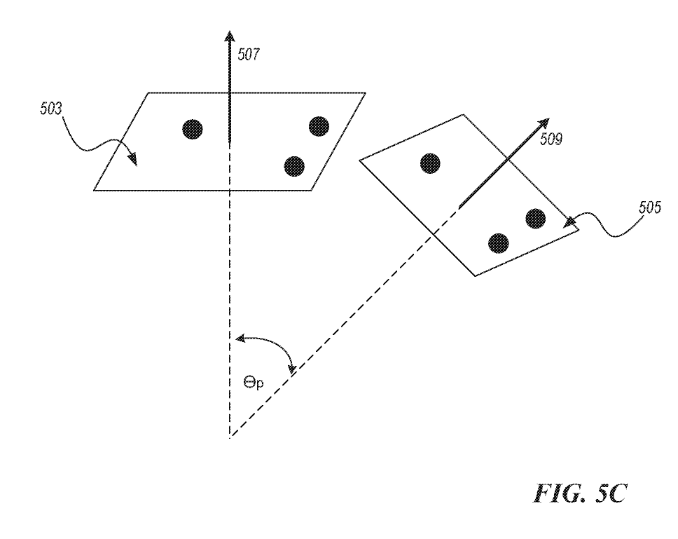

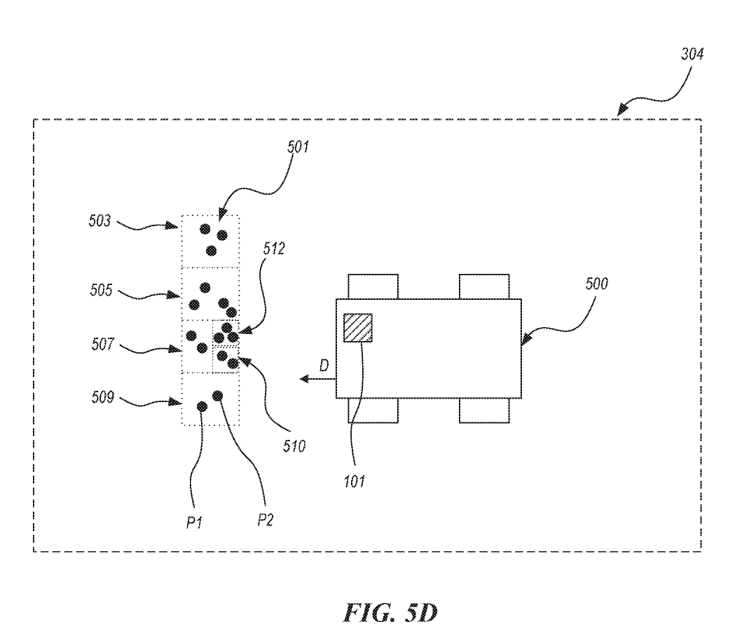

The analysis component 109 is configured to analyze the collected distance information and/or images so as to (1) identify the object 10 (as discussed in further detail with reference to FIGS. 2 and 5A-5C), and/or (2) determine a surface of object 10 based on a gradient variation analysis (as discussed in further detail with reference to FIGS. 3 and 4A-4D). Based on the result of the analysis, the analysis component 109 can also perform a route planning task for the system 100b.

FIG. 2 is a schematic, isometric diagram illustrating voxel grids or 3-D grids and a point cloud configured in accordance with representative embodiments of the present technology. To collect environmental information (e.g., information about surrounding object/obstacles and the distance between them and the distance-measurement component 101), the distance-measurement component 101 can emit (outwardly) at least one electromagnetic ray and then receive one or more reflected electromagnetic rays. The distance-measurement component 101 can then calculate the time of flight of the emitted ray and the reflected ray, and determine the distance between the distance-measurement component 101 and the object that reflects the rays toward the distance-measurement component 101. As shown in FIG. 2, the distance-measurement component 101 is configured to generate a point cloud 201. The environmental information collected/generated by the distance-measurement component 101 can be in a form/format of a set of multiple points (e.g., collectively the point cloud 201). Sometimes the point cloud 201 can include noise that cannot be used to determine an object or a surface surrounding the distance-measurement component 101. In such cases, the present technology can analyze or “downsample” the point cloud 201 to remove the redundant part of the point cloud 201, while still keeping the accuracy of the point cloud 201 at an acceptable level (e.g., still can be used to identify an object or a surface). Another benefit of having a smaller point cloud 201 includes that it requires fewer computing resources and time to analyze.

As shown in FIG. 2, the point cloud 201 includes multiple 3-D points unevenly distributed in a 3-D space defined by coordinate axes X, Y and Z. These 3-D points can each be located or identified by corresponding 3-D coordinates. For example, each of the points can have a corresponding 3-D coordinate (x, y, z). Based on the points' locations, the present technology can assign each of the 3-D points to a corresponding one voxel grid (or 3-D grid).

The present technology can then determine a number of the 3-D points in each of the voxel grids. For example, in FIG. 2, a first voxel grid 203 includes ten 3-D points, a second voxel grid 205 includes four 3-D points, and a third voxel grid 207 includes one 3-D point. The present technology can then use the numbers of 3-D points in the voxel grids to analyze or “downsample” the point cloud 201 (e.g., so as to select a subset of the voxel grids). For example, a threshold value of the numbers of 3-D points for each voxel grid can be determined based on empirical data (e.g., generated by empirical study, machine learning processes, or other suitable methods). Factors for determining the threshold value includes the size of the voxel grids, the type/characteristics/accuracy of the distance-measurement component 101, ambient conditions (e.g., weather conditions), and/or other suitable factors. In the illustrated embodiment of FIG. 2, assuming that the threshold value is “2,” then the point cloud 201 can be updated or downsampled by removing the point in the third voxel grid 207, because the number of 3-D points in this grid (1) does not exceed the threshold value (2).

In some embodiments, the downsampling process can be performed based on different criteria or predetermined rules. Purposes of the downsampling process include screening out redundant 3-D points for each grid by selecting/identifying one or more representative points to be remained therein. For example, for each voxel grid, the present technology can determine the location of the center of mass of all the original 3-D points therein (e.g., assuming that all the original 3-D points have equal mass), and then position a new 3-D point (or a few new 3-D points) at that determined location of the center of mass to represent all the original 3-D points. The new 3-D points in all the voxel grids then constitute the downsampled point cloud.

The downsampling process can effectively remove noise (e.g., the point in the third voxel grid 207) from the point cloud 201 and therefore enhance the quality and accuracy of the point cloud 201. In addition, the size of the point cloud 201 is reduced by the downsampling process and accordingly further processing requires fewer computing resources. The downsampled point cloud 201 can be used to identify a ground surface (e.g., to be discussed in further detail with reference to FIGS. 3 and 4A-4D) or an object/obstacle (e.g., to be discussed in further detail with reference to FIGS. 5A-5C).

In some embodiments, the size of the voxel grids can be different. For example, the voxel grids in areas of interest (e.g., an area next to a vehicle, an area in the traveldirection of a vehicle, or an area underneath a UAV or other flight vehicle) can have smaller-sized grids than other areas, such that the downsampled point cloud 201 can have higher grid resolution in the areas of interest (to be discussed in further detail below with reference to FIGS. 5A and 5D).

FIG. 3 is a schematic cross-sectional view illustrating a movable device 300 configured in accordance with representative embodiments of the present technology. The moveable device 300 moves in a travel direction D and carries a distance-measurement component 101 configured to generate a point cloud 301. The point cloud 301 is downsampled or analyzed in the ways similar to those discussed above with reference to FIG. 2. By further analyzing the downsampled point cloud 301, the moveable device 300 can determine characteristics of an actual ground surface 302 on which it moves. As shown in FIG. 3, the downsampled point cloud 301 can include multiple 3-D points, each of which includes a height value relative to a reference surface 304. As previously discussed, each of the multiple 3-D points is individually assigned to one of the voxel grids (FIG. 2). As shown in FIG. 3, multiple voxel grids can be “stacked” in a particular direction (e.g., a vertical direction Dv indicated in FIG. 3) that is vertical or normal to the reference surface 304 to form a grid column. For illustration purposes, there are only three grid columns (i.e., a first column 303, a second column 305, and a third column 307) shown in FIG. 3. In other embodiments, the downsampled point cloud 301 can be analyzed based on different numbers of grid columns. For example, the sizes of the gird columns can vary depending on the locations of the grid columns. In some embodiments, the grid columns close to the movable device 300 can be smaller than those away from the the movable device 300.

For each of the first/second/third grid columns 303, 305 and 307, a point with a minimum height value (e.g., compared to other points in the same grid column) is selected. These points are identified as first/second/third ground points P₁, P₂ and P₃. As shown, the first ground point P₁ has a corresponding first height value H₁ (e.g., which can be derived from the “z” coordinate value discussed above with reference to FIG. 2), the second ground point P₂ has a corresponding second height value H₂, and the third ground point P₃ has a corresponding third height value H₃. Based on the three ground points P₁, P₂, and P₃, an initial ground surface (or first ground surface) 309 can be generated (e.g., by connecting or curve-fitting the ground points). The initial ground surface 309 includes a height profile HP generated based on the height values H₁, H₂, and H₃. The initial ground surface 309 represents an estimation of the actual ground surface 302. The initial ground surface 309 can be further analyzed by a gradient analysis variation. Relevant embodiments of the gradient analysis variation are discussed below with reference to FIGS. 4A-4D.

FIGS. 4A-4D are schematic diagrams illustrating methods for analyzing a ground surface in accordance with representative embodiments of the present technology. FIG. 4A is a top schematic view illustrating multiple “virtual” ground-point-identifying rays that are used to perform a gradient variation analysis for identified ground points (or a ground surface). The distance-measurement component 101 can generate a point cloud based on reflected electromagnetic rays. The point cloud can then be downsampled (e.g., in the ways described above with reference to FIG. 2). Multiple ground points 401 can then be selected from the downsampled point cloud (e.g., in the ways described above with reference to FIG. 3). As shown in FIG. 4A, the ground points 401 are distributed in different grids.

As shown in FIG. 4A, the distance-measurement component 101 can emit a continuous electromagnetic ray and moves the ray between first and second surface-detecting directions D₁ and D₂. The two surface-detecting directions D₁ and D₂ together define a “virtual” scanning region 403. To initiate a gradient variation analysis, multiple virtual ground-point-identifying rays (e.g., a first ray R₁, a second ray R₂, and a third R₃ in the first surface-detecting direction D₁ shown in FIG. 4A) are generated. The virtual ground-point-identifying rays are not actual, physical rays. Instead, they are virtual rays that are used to identify a first group of ground points, a first ground point Pₖ₋₁, a second ground point Pₖ, and a third ground point Pₖ₊₁ in the first surface-detecting direction D₁, and multiple a second group of ground points Q₁, Q₂, and Q₃ in the second surface-detecting direction D₂, for a gradient variation analysis in particular directions across the virtual scanning region 403. In some embodiments, the virtual scanning region can be a 360-degree region, a 180-degree region, a 90-degree region, a 45-degree region, or other suitable region.

In some embodiments, before performing the gradient variation analysis, the first ground point P₁ and the second ground point P₂ can be verified based on the location of the distance-measurement component 101 (or the location of a moveable device) relative to the actual ground surface. Because the location (e.g., height) of the distance-measurement component 101 relative to the actual ground surface is known (e.g., 1 meter above the actual ground surface), it can be used to verify whether the first ground point P₁ and the second ground point P₂ are suitable points to start the gradient variation analysis. For example, if the height values (e.g., H₁ and H₂ shown in FIG. 4B) corresponding to the first and second ground points P₁, P₂ indicate that at least one of these two ground points is far away from the actual ground surface (e.g., larger than a threshold value, such as 15 centimeters), the present technology can then choose other ground points (e.g., the third ground P₃ or other ground points in the first ray R₁) to start the gradient variation analysis. In other embodiments, the present technology can adjust the height values corresponding to the first and second ground points P₁, P₂ based on the actual ground surface and then still start the gradient variation analysis at the first and second ground points P₁, P₂.

FIG. 4B illustrates representative techniques for identifying the first group of ground points Pₖ₋₁, Pₖ, and Pₖ₊₁ in the first surface-detecting direction D₁ via the virtual ground-point-identifying rays R₁, R₂, and R₃. The first ground point Pₖ₋₁ has a first height value H₁, the second ground point Pₖ has a second height value H₂, and the third ground point Pₖ₊₁ has a third height value H₃. As shown in FIG. 4B, the first virtual ground-point-identifying ray R₁ is “virtually” emitted from the distance-measurement component 101 to ground point Pₖ₋₁. The first virtual ray R₁ and the reference surface 304 together form an angle θ_{R1} (e.g., a first gradient value at the first ground point Pₖ₋₁). Similarly, the second and third virtual rays R₂, R₃ are also virtually emitted from the distance-measurement component 101 to corresponding second and third ground points Pₖ, Pₖ₊₁. Relative to the reference surface 304, the second and third virtual rays R₂ and R₃ respectfully form angle θ_{R2} (e.g., a second gradient value at the second ground point Pₖ) and θ_{R3} (e.g., a third gradient value at the third ground point Pₖ₊₁). Techniques in accordance with embodiments of the present technology then then be used to analyze the first, second, and third gradient values, θ_{R1}, θ_{R2}, and θ_{R3} to determine whether the second and third height values H₂, H₃ need to be adjusted.

A threshold angle value θ_{T} can be determined based on empirical data or other suitable factors (e.g., sizes of the voxel grids or characteristics of the cloud point). In the illustrated embodiments, if the difference between the second gradient value θ_{R2} and the first gradient value θ_{R1} is greater than the threshold angle value eT, then the second height value H₂ is replaced by the first height value H₁. When the gradient variation analysis is completed at the second ground point Pₖ, the method then continues to analyze the gradient variation at the third ground point Pₖ₊₁. Similarly, if the difference between the third gradient value θ_{R3} and the second gradient value θ_{R2} is greater than the threshold angle value θ_{T}, then the third height value H₃ is replaced by the second height value H₂. After the gradient variation analysis, the present technology can update the height values of the ground points so as to generate an analyzed ground surface. Because a sudden change of gradient at one ground point may be caused by an object (discussed with reference to FIG. 4C) or a recess (discussed with reference to FIG. 4D), the gradient variation analysis can effectively remove such a ground-surface distortion (e.g., incorrectly consider an object to be part of a ground surface) and therefore enhance the accuracy of the analyzed ground surface.

Other ground points (e.g., the second group of ground points Q₁, Q₂ and Q₃ in FIG. 4A) in the virtual scanning region 403 can be analyzed in ways similar to those described above regarding the first group of ground points Pₖ₋₁, Pₖ, and Pₖ₊₁. After completing the gradient variation analysis for the whole virtual scanning region 403, the analyzed surface can be further used to plan a route for a moveable device. In some embodiments, the present technology can record height adjustments regarding which ground point has a height adjustment. Such records can be further used for identifying an object (e.g., a projection extending from or an article located above a ground surface, or a recess below a ground surface) when performing a route planning task. In some embodiments, the present technology can analyze gradient variations between two non-adjacent points (e.g., the first ground point Pₖ₋₁ and the third ground point Pₖ₊₁) to generate the analyzed ground surface. In other words, the present technology enables a user to adjust the resolution of the analyzed ground surface by “skipping” some ground points.

In some embodiments, the surface-detecting direction can include multiple sections (or rays). For example, with reference to FIG. 4A, the surface-detecting direction can start from the distance-measurement component 101, continue to ground point Pₖ₋₁, further move to ground point Q₁, and then go to ground point Pₖ. In such embodiments, the surface-detecting direction can be determined by finding a next ground point that is closest to the distance-measurement component 101 within a sector virtual region (e.g., defined by the surface-detecting directions D₁, D₂). In other embodiments, the ground points can be identified or selected based on other suitable criteria or rules.

In some embodiments, the sector virtual region can be further divided into multiple sections (e.g., based on distances relative to the distance-measurement component 101). For each section, a ground point can be determined (e.g., by selecting a ground point closest to the distance-measurement component 101 in each section). For example, the sector virtual region can include a first section, a second section, and a third section. The first ground point Pₖ₋₁ can be selected from the ground points in the first section, the second ground point Pₖ can be selected from the ground points in the second section, and the third ground point Pₖ₊₁ can be selected from the ground points in the third section. The selected first, second and third points Pₖ₋₁, Pₖ, Pₖ₊₁ can then be used to perform the gradient variation analysis as described above.

FIGS. 4C and 4D are schematic diagrams illustrating details of a representative gradient variation analysis. In FIG. 4C, a first ground-point-identifying ray R₁ is virtually emitted from a first ground point Pₖ₋₁ to a second ground point Pₖ. A second ground-point-identifying ray R₂ is virtually emitted from the second ground point Pₖ to a third ground point Pₖ₊₁. The first ground point Pₖ₋₁ has a first gradient value “∇h_{k-1,k}” (e.g., a first angle θₖ), and the second ground point Pₖ has a second gradient value “∇h_{k,k+1}” (e.g., a second angle θₖ₊₁). As shown in FIG. 4C, the first and second gradient values can be calculated based on Equations (A) and (B) below, where “x” represents the distance between two ground points in a direction parallel to axis X and “Height” represents a height difference between two ground points in a direction parallel to axis Z.

∇h_{k-1,k}=arctan(Height(Pₖ,Pₖ₋₁)/(xₖ−xₖ₋₁)) (A)

∇h_{k,k+1}=arctan(Height(Pₖ₊₁,Pₖ)/(xₖ₊₁−xₖ)) (B)

Based on Equations (A) and (B) above, a gradient variation value (e.g., the absolute value of “∇h_{k,k+1}−∇h_{k-1,k}”) between two ground points (e.g., the first and second ground points Pₖ₋₁ and Pₖ) or two ground-point-identifying rays (e.g., first and second rays R₁ and R₂) can be determined.

Once the gradient variation value is determined, it can be compared to a threshold gradient value. In a manner similar to those discussed above with reference to FIG. 4B, if the gradient variation value exceeds the threshold gradient value, then height value Zₖ at the second ground point Pₖ is replaced by height value Zₖ₋₁. In such embodiments, an analyzed ground surface 409 can be generated.

In the illustrated embodiments shown in FIG. 4C, the analyzed surface 409 is generated by screening out ground points that may correspond to a relatively small object/obstacle projecting above the actual ground surface. In the illustrated embodiments shown in FIG. 4D, the analyzed surface 409 is generated by screening out ground points that may correspond to a relatively small recess or hole below the actual ground surface. In both cases, what constitutes “small” can be controlled by appropriately selecting the threshold value(s), e.g., the threshold gradient value or the threshold angle value.

In some embodiments, the gradient variation value can be directional (e.g., to distinguish whether a gradient angle is a “clockwise” angle or a “counterclockwise” angle) such that a user can select whether to consider an object (e.g., FIG. 4C) or a recess (e.g., FIG. 4D) when generating the analyzed surface 409. For example, in FIG. 4C, the gradient variation between the first ground point Pₖ₋₁ and the second ground point Pₖ is “counterclockwise” (e.g., the first ray R₁ rotates in the counterclockwise direction to align with the second ray R₂, in the plane of FIG. 4C). By contrast, in FIG. 4D, the gradient variation between the first ground point Pₖ₋₁ and the second ground point Pₖ is “clockwise” (e.g., the first ray R₁ rotates in the clockwise direction to align with the second ray R₂, in the plane of FIG. 4D). In some embodiments, the user can choose not to adjust (e.g., smooth) the height of the ground points for the “clockwise” gradient variation (e.g., if the user wishes to retain the details of recesses or holes). In other embodiments, the user can choose not to adjust (e.g., smooth) the height of the ground points for the “counterclockwise” gradient variation (e.g., if the user wishes to retain the details of the projections). Accordingly, the present technology enables the user to perform the gradient variation analysis in various ways.

FIG. 5A is a schematic diagram (top view) illustrating methods for identifying objects by various types of grids in accordance with representative embodiments of the present technology. As shown in FIG. 5A, a movable device 500 includes a distance-measurement component 101 configured to generate a point cloud. The point cloud can be analyzed and then used to identify objects D, E, and F located relative to the moveable device 500. As shown in FIG. 5A, object D is located relatively far away from the moveable device 500 (area D), object E is located on one side of the moveable device 500 (area E), and object F is located in front of the moveable device 500 (area F).

In the illustrated embodiments, the present technology can use large-sized grids in area D, intermediate-sized grids in area E, and small-sized grids in area F to analyze the point cloud. Accordingly, the point cloud can be analyzed via different grid resolutions depending on the distance between the moveable device and the object of interest, and/or the direction to the object. For example, because area F is in the direction that the moveable device 500 travels, a user may want to use the small-sized grids to analyze the point cloud so as to have a high resolution of the result. It may also be important (though perhaps less important) for a user to understand whether there is any obstacle on the side of the moveable device 500 and accordingly, the user may select the intermediate-sized grids in area E. As for area D, because it is relatively far away from the moveable device 500 (and accordingly, the accuracy of the cloud point in this area is generally lower than it is for an area closer to the distance measurement-component 101, such as areas E and F), the user may want to allocate fewer computing resources to analyzing the cloud point in that area. Therefore, using large-sized grids in area D can be a suitable choice.

In some embodiments, the sizes of the grids can be adjusted dynamically. More particularly, when the travel direction of the moveable device 500 changes (e.g., the moveable device 500 turns), the grid sizes can be changed accordingly to meet the needs for high resolution analysis in the new travel direction. For example, when the moveable device 500 is about to make a turn toward object E, the grid size in area E can be adjusted dynamically (e.g., in response to a turn command received by a controller of the moveable device 500, the grid size in area E is reduced). In some embodiments, the sizes of the grids can be determined based on the locations of the grids relative to the moveable device 500. For example, the grids in a short range (e.g., within 20 meters) can have a small size. The grids in an intermediate range (e.g., 20-40 meters) can have an intermediate size. The grids in a long range (e.g., more than 40 meters) can have a large size.

In some embodiments, the result of analyzing one set of grids can be used to verify the result of analyzing another set of grids. For example, as shown in FIG. 5A, object E can be identified as either a moving vehicle or a moving pedestrian in area E. Object D can be identified as a building in area D. The distance between object D and object E can be determined. Assuming empirical data suggests that a moving vehicle cannot be located within a close range (e.g., 1 meter) of a building, the technology can accordingly determine that object E is a moving vehicle or a moving pedestrian.

FIGS. 5B and 5C are schematic diagrams illustrating methods for analyzing cloud points in accordance with representative embodiments of the present technology. In FIG. 5B, multiple cloud points are unevenly distributed in grids A, B, C, and D. Grids A, B, C, and D have point densities Da, Db, Dc and Dd, respectively. In some embodiments, the present technology can use the point densities (e.g., the number of the cloud points in a grid) to determine whether the cloud points in two grids correspond to the same object/obstacle.

In the illustrated example of FIG. 5B, Da can be “3,” Db can be “9,” Dc can be “2,” and Dd can be “7.” Assume the rule is, for example, that if the point densities of two adjacent grids are both greater than 6, then the cloud points in the two adjacent grids are considered to correspond to the same object. In such a case, the present technology can determine that the cloud points in grid B and grid D correspond to the same object.

In some embodiments, if the point densities are generally the same (e.g., within 10% of each other), the present technology can determine that the associated cloud points correspond to the same object/obstacle. The result of such a determination can be further verified by other information (e.g., by image/color information collected by an image component of a moveable device).

In some embodiments, the present technology can determine whether two cloud points correspond to the same object/obstacle by analyzing the distance therebetween. For example, as shown in FIG. 5B, a first distance dl between cloud points P₁ and P₂ is greater than a second distance between cloud points P₂ and P₃. Accordingly, the present technology can determine that cloud points P₂ and P₃ may correspond to the same object/obstacle. In some embodiments, the distances between the cloud points can be analyzed by other suitable methods (e.g., calculating an average distance between the cloud points in one grid, and then compare the average distance with another grid).

In some embodiments, the present technology can determine whether multiple cloud points correspond to the same object/obstacle by analyzing a distribution pattern thereof. For example, as shown in FIG. 5B, the present technology can compare a distribution pattern 502 with empirical data (e.g., previously identified cloud points) to see if there is a match. For example, in some embodiments, if the relative locations of more than 60% of the points of a pattern are the same as those of another pattern, then the system can identify a match. In some embodiments, the cloud points can be further analyzed or verified based on color information (e.g., images, pixel information etc.) or color patterns (e.g., a color distribution of an object, such as the green color pattern of a street tree) corresponding to these points.

In some embodiments, methods in accordance with the present technology can determine whether multiple cloud points correspond to the same object/obstacle by performing a normal-vector analysis. For example, as shown in FIG. 5C, the present technology can select first and second sets of cloud points (e.g., both having at least three cloud points) to form a first reference plane 503 and a second reference plane 505. The first reference plane 503 has a first normal vector 507, and the second reference plane 505 has a second normal vector 509. As shown in FIG. 5C, the first normal vector 507 and the second normal vector 509 form a plane angle θₚ. If the plane angle is smaller than a threshold value (e.g., 10-40 degrees), then the first and second sets of points can be determined as corresponding to the same object/obstacle.

FIG. 5D is a schematic diagram (top view) illustrating methods for identifying a ground-surface texture via various types of grids in accordance with representative embodiments of the present technology. The moveable device 500 shown in FIG. 5D is capable of measuring a ground-surface texture (e.g., a flat road, a rough road, a paved road, an unpaved road, a cobblestone road, or an asphalt road) via various types of grids. The moveable device 500 includes a distance measurement-component 101 configured to generate a point cloud. The point cloud can be downsampled or analyzed by multiple voxel grids. Representative downsampling processes were described above with reference to FIG. 2. The downsampled point cloud can be used to extract multiple ground points 501. Representative embodiments describing processes of extracting the ground points were discussed above with reference to FIG. 3. In some embodiments, the ground points can be processed by the gradient variation analysis, as discussed above with reference to FIGS. 4A-4D.

As shown in FIG. 5D, method in accordance with the present technology can include further analyzing the ground points 501 by projecting them onto a reference surface (e.g., the reference surface 304). The projected ground points then can be individually assigned to one of multiple two-dimensional (2-D) grids 503, 505, 507 and 509. In some embodiments, the size of the 2-D grids can be larger than the size of the 3-D grids for the downsampling process (such that the 2-D grids can include sufficient projected ground points to analyze). For each 2-D grid, an average height value can be calculated based on the height values of the ground points in that 2-D grid. For example, 2-D grid 509 includes two ground points P₁, P₂. Ground point P₁ has a first height value, and ground point P₂ has a second height value. In some embodiments, the average height value of 2-D grid 509 can be calculated by averaging the first and second height values. In other embodiments, the average height value of the 2-D grid can be calculated by other suitable methods. When the average height values of all the 2-D grids are calculated, the average height values can then be further analyzed (e.g., to determine a median value of the average height values, a statistical variance, or other suitable parameters and then compare the determined value with empirical data) to determine the road-surface texture.

In some embodiments, the ground points can be further analyzed by small-sized 2-D grids (e.g., 2-D grids 510, 512) in certain areas (e.g., close to the moveable device 500). By so doing, embodiments of the present technology can determine the ground-surface texture, which can be further used for route planning for the moveable device 500.

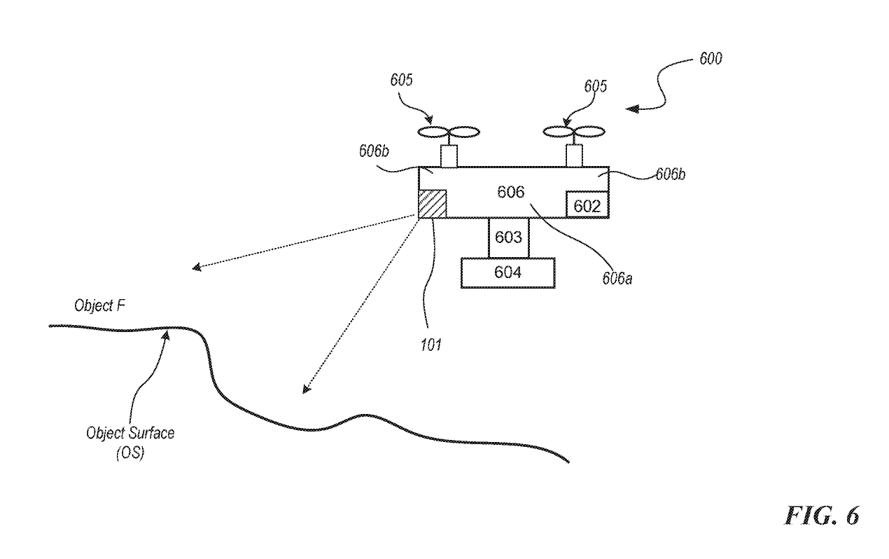

FIG. 6 is a schematic diagram illustrating a UAV 600 configured in accordance with representative embodiments of the present technology. The UAV 600 includes a distance-measurement component 101, an airframe (or a main body) 606, a UAV controller 602 carried by the UAV 600 and configured to control the UAV 600, a gimbal 603 coupled to the airframe 606, and a UAV payload 604 coupled to and carried by the gimbal 603. The distance-measurement component 101 is configured to generate a point cloud. The point cloud can be analyzed and then used to identify an object F (having an object surface OS) located relative to the UAV 600. The analyzed point cloud can then be used to plan a flight route for the UAV 600.

In some embodiments, the UAV payload 604 can include an imaging device configured to collect color information that can be used to analyze the point cloud. In particular embodiments, the imaging device can include an image camera (e.g., a camera that is configured to capture video data, still data, or both). The camera can be sensitive to wavelengths in any of a variety of suitable wavelength bands, including visual, ultraviolet, infrared or combinations thereof. In further embodiments, the UAV payload 604 can include other types of sensors, other types of cargo (e.g., packages or other deliverables), or both. In many of these embodiments, the gimbal 603 supports the UAV payload 604 in a way that allows the UAV payload 604 to be independently positioned relative to the airframe 606.

The airframe 606 can include a central portion 606a and one or more outer portions 606b. In particular embodiments, the airframe 606 can include four outer portions 606b (e.g., arms) that are spaced apart from each other as they extend away from the central portion 606a. In other embodiments, the airframe 606 can include other numbers of outer portions 606b. In any of these embodiments, individual outer portions 606b can support one or more propellers 605 of a propulsion system that drives the UAV 600. The UAV controller 602 is configured to control the UAV 600. In some embodiments, the UAV controller 602 can include a processor coupled and configured to control the other components of the UAV 600. In some embodiments, the controller 602 can be a computer. In some embodiments, the UAV controller 602 can be coupled to a storage component that is configured to, permanently or temporarily, store information associated with or generated by the UAV 600. In particular embodiments, the storage component can include a disk drive, a hard disk, a flash drive, a memory, or the like. The storage device can be used to store the collected point cloud and the color information.

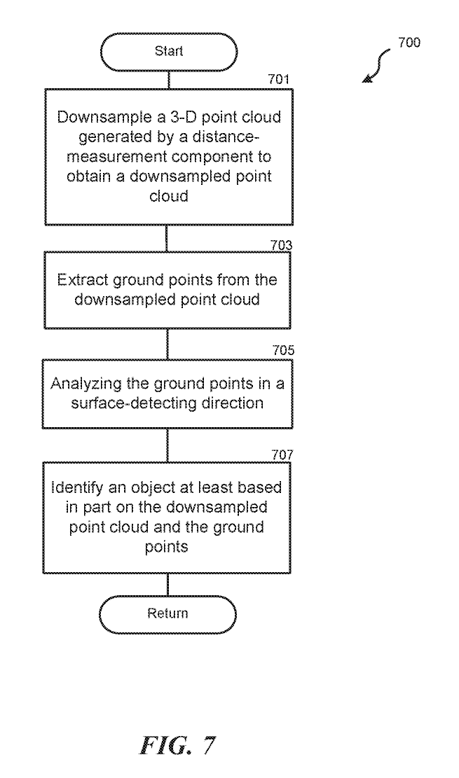

FIG. 7 is a flowchart illustrating a method 700 in accordance with representative embodiments of the present technology. The method 700 is used to identify objects/obstacles located relative to a movable device. The method 700 includes downsampling a 3-D point cloud generated by the distance-measurement component using voxel grids to obtain a downsampled point cloud (block 701). Embodiments of the downsampling process are discussed above in further detail with reference to FIG. 2. At block 703, the method 700 includes extracting ground points from the downsampled point cloud. Examples of extracting the ground points are discussed above in further detail with reference to FIG. 3. At block 705, the method 700 includes analyzing the ground points in a surface-detecting direction. Examples of analyzing the ground points are discussed above in further detail with reference to FIGS. 4A-4D. At block 707, the method 700 includes identifying an object based at least in part on the downsampled point cloud and the ground points. Examples of the techniques for identifying the object based on the downsampled point cloud and the ground points are discussed above in further detail with reference to FIGS. 5A-5D. The identified object can then be used to plan a route for the movable device.

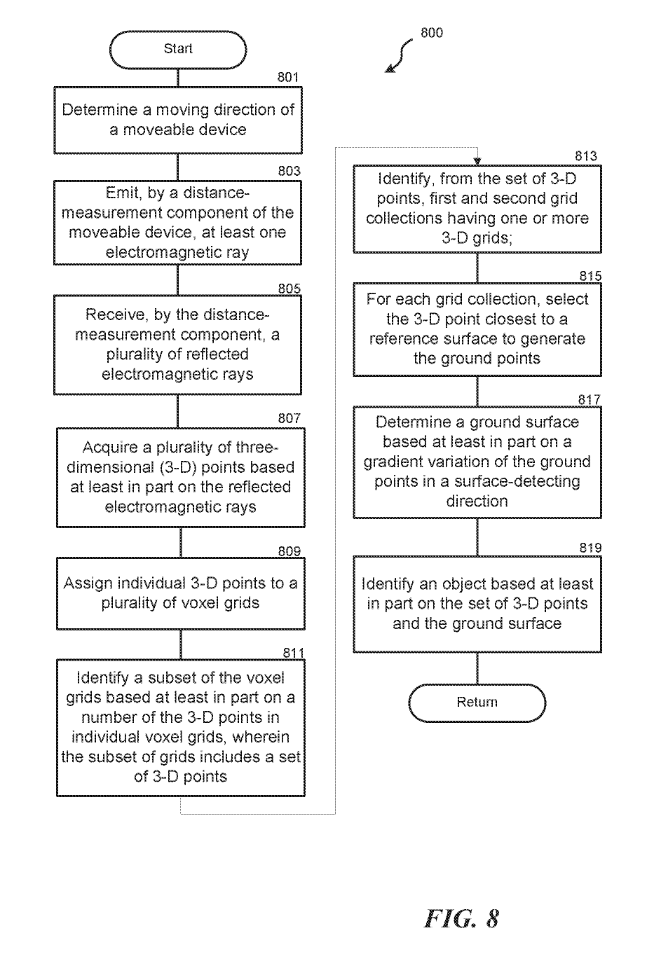

FIG. 8 is a flowchart illustrating a method 800 in accordance with representative embodiments of the present technology. The method 800 can be implemented to operate a moving device (e.g., a UAV and/or other vehicle). Block 801 includes determining a moving direction of the moveable device. At block 803, the method 800 includes emitting, by a distance-measurement component of the moveable device, at least one electromagnetic ray. At block 805, the method 800 includes receiving, by the distance-measurement component, a plurality of reflected electromagnetic rays. In some embodiments, the distance-measurement component can emit a continuous electromagnetic ray and then continuously receive the reflected electromagnetic rays. Based on the reflected electromagnetic rays, at block 807, a plurality of 3-D points is generated or acquired. At block 809, individual 3-D points are assigned to a plurality of voxel grids. At block 811, the method 800 includes identifying a subset of the voxel grids based at least in part on a number of the 3-D points in individual voxel grids. The subset of grids includes a set of 3-D points. At block 813, the method 800 includes identifying, from the set of 3-D points, first and second grid collections (e.g., grid columns described above with reference to FIG. 3) having one or more 3-D grids. At block 815, for each grid collection, the 3-D point closest to a reference surface is selected. All selected 3-D points constitute selected ground points. In some embodiments, the ground points can be used to generate an initial or first ground surface (e.g., the initial or first ground surface 309).

At block 817, the method 800 includes determining a second ground surface (e.g., the analyzed surface 409) based at least in part on a gradient variation of the first surface contour in a surface-detecting direction. At block 819, an object is identified based at least in part on the set of 3-D points and the second ground surface. The identified object can be further used for planning a route for the movable device. The moveable device can then be operated according to the planned route.

As discussed above, aspects of the present technology provide improved methods and associated systems for identifying objects/obstacles and/or surfaces based on a generated point cloud. By removing noise and/or redundant information in the point cloud, the present technology can provide useful environmental information for route planning. Another feature of some embodiments includes enabling a user to customize the way to analyze(s) in which a generated point cloud is analyzed. For example, the user can dynamically adjust the size of the grids used to analyze the generated point cloud.

In some embodiments, some or all of the processes or steps described above can be autonomously implemented by a processor, a controller, a computer, or other suitable devices (e.g., based on configurations predetermined by a user). In some embodiments, the present technology can be implemented in response to a user action (e.g., the user rotating a steering wheel) or a user instruction (e.g., a turn command or a vehicle).

From the foregoing, it will be appreciated that specific embodiments of the presently disclosed technology have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein.

At least a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. A method for identifying an object located relative to a movable device having a distance-measurement component, the distance-measurement component being configured to generate a 3-D point cloud, the method comprising:
downsampling a 3-D point cloud generated by the distance-measurement component to obtain a downsampled point cloud;
extracting ground points from the downsampled point cloud;
analyzing the ground points in a surface-detecting direction; and
identifying the object based at least in part on the downsampled point cloud and the ground points.

2. The method of claim 1, further comprising analyzing the ground points based at least in part on a gradient variation analysis between at least two points in the downsampled point cloud.

3. The method of claim 1, further comprising determining the surface-detecting direction based at least in part on a direction corresponding to at least one electromagnetic ray emitted by the distance-measurement component.

4. The method of claim 1, wherein the distance-measurement component is configured to receive a plurality of reflected electromagnetic rays, and wherein the method further comprises:
generating the 3-D point cloud based at least in part on a plurality of 3-D points corresponding to the reflected electromagnetic rays;
downsampling the 3-D point cloud using voxel grids to obtain the downsampled point cloud; and
assigning individual 3-D points to the voxel grids.

5. The method of claim 4, further comprising:
identifying a subset of the voxel grids based at least in part on a number of the 3-D points in each of the voxel grids, wherein the subset of grids includes a set of 3-D points forming the downsampled point cloud.

6. The method of claim 5, further comprising:
determining multiple vectors normal to a reference surface based at least in part on locations of the subset of the voxel grids;
identifying, from the set of 3-D points, a point closest to the reference surface on each of the multiple vectors to generate the ground points, wherein the multiple vectors.

7. The method of claim 6, wherein identifying the point on each of the multiple vectors normal to the reference surface comprises determining a height profile relative to the reference surface.

8. The method of claim 1, further comprising:
identifying a first ground point and a second ground point in the surface-detecting direction;
wherein the first ground point is closer to the distance-measurement component than the second ground point; and
wherein the first ground point has a first height value; and
wherein the second ground point has a second height value.

9-31. (canceled)

32. A system for identifying an object located relative to a movable device, the system comprising:
a distance-measurement component configured to generate a 3-D point cloud;
a computer-readable medium coupled to the distance-measurement component and configured to:
downsample the 3-D point cloud generated by the distance-measurement component using voxel grids to obtain a downsampled point cloud;
extract ground points from the downsampled point cloud;
analyze the ground points in a surface-detecting direction; and
identify the object based at least in part on the downsampled point cloud and the ground points.

33. The system of claim 32, wherein the computer-readable medium is further configured to:
generate the 3-D point cloud by generating a plurality of 3-D points based at least in part on a plurality of reflected electromagnetic rays identified by the distance-measurement component;
assign individual 3-D points to the voxel grids.

34. The system of claim 33, wherein the computer-readable medium is further configured to:
identify a subset of the voxel grids based at least in part on a number of the 3-D points in each of the voxel grids, wherein the subset of grids includes a set of 3-D points forming the downsampled point cloud.

35. The system of claim 34, wherein the computer-readable medium is further configured to:
identify, from the set of 3-D points, a first grid collection having one or more girds;
identify, from the set of 3-D points, a second grid collection having one or more girds; and
for each grid collection, select the 3-D point closest to a reference surface to generate the ground points.

36. The system of claim 32, wherein the computer-readable medium is further configured to analyze the ground points based at least in part on a gradient variation analysis between adjacent points in the downsampled point cloud.

37. The system of claim 32, wherein the computer-readable medium is further configured to determine the surface-detecting direction based at least in part on a direction corresponding to at least one electromagnetic ray emitted by the distance-measurement component.

38. The system of claim 32, further comprising:
an image component configured to receive color information associated with the downsampled point cloud;
wherein the computer-readable medium is further configured to:
determine, based at least in part on the color information, a color pattern of the downsampled point cloud;
identify an object candidate based at least in part on the color pattern; and
based at least in part on the object candidate, identify the object.

39. The system of claim 38, wherein the image component is further configured to receive individual pixel information associated with the downsampled point cloud, and wherein the computer-readable medium is further configured to identify the object candidate based at least in part on the individual pixel information.

40. The system of claim 32, wherein the distance-measurement component comprises a Lidar component.

41. The system of claim 32, wherein the distance-measurement component comprises a Ladar component.

42. The system of any claim 32, wherein the distance-measurement component is configured to emit at least one electromagnetic ray in directions designated by a user.

43. The system of claim 32, wherein the distance-measurement component is configured to emit at least one electromagnetic ray in directions generally parallel to a direction in which the moveable device moves.

44. The system of claim 32, wherein the distance-measurement component is configured to emit at least one electromagnetic ray in directions generally perpendicular to a direction in which the moveable device moves.

45. The system of claim 32, wherein the distance-measurement component is configured to emit at least one electromagnetic ray in response to a turn command.

46. The system of claim 32, wherein the distance-measurement component comprises a plurality of emitters.

47. The system of claim 32, wherein the distance-measurement component comprises a plurality of receivers.

48. The system of claim 47, wherein each of the receivers corresponds to an emitter.

49-58. (canceled)
